(19) United States
(12) Patent Application Publication
(10) Pub. No.: US 2024/0014499 A1
(43) Pub. Date: Jan. 11, 2024

(54) CELL RETAINER ASSEMBLY AND METHOD THEREOF

(71) Applicant: EXICOM TELE-SYSTEMS LIMITED, Bangalore (IN)

(72) Inventors: Sundaraaman K.V, Bangalore (IN); Vijay Kumar, Bangalore (IN)

(73) Assignee: EXICOM TELE-SYSTEMS LIMITED, Bangalore (IN)

(21) Appl. No.: 18/034,596

(22) PCT Filed: Mar. 29, 2021
(86) PCT No.: PCT/IN2021/050321

§ 371 Date: Apr. 28, 2023

(30) Foreign Application Priority Data
Nov. 3, 2020 (IN) 202011047937

(51) Int. Cl. H01M 50/264; H01M 50/213; H01M 50/291; H01M 50/502; H01M 10/613; H01M 10/643; H01M 10/6554

(52) U.S. Cl. CPC H01M 50/264; H01M 50/213; H01M 50/291; H01M 50/502; H01M 10/613; H01M 10/643; H01M 10/6554

(57) ABSTRACT

A cell retainer assembly includes a cell holder unit. The cell holder unit includes a first and a second member having a first and a second set of through holes respectively. The first and the second set of through holes is adapted to receive and position a plurality of cells therein. A groove is formed at a first and a second end of the first and second set of through holes. The groove is formed along an internal portion of one of the first and the second set of through holes. The groove has a length lesser than a length of each of the first and the second through holes. Further, the groove is adapted to receive adhesive therein to retain each of the plurality of cells within the first and the second set of through holes.

### FIELD OF THE INVENTION

The present invention relates to a battery pack, and more particularly relates to individually retaining each of a plurality of cells within the battery pack.

### BACKGROUND OF THE INVENTION

With rise in pollution, environmental hazards caused by the usage of fossil fuels, and depletion of fossil fuels, batteries are predominantly being used as energy storages in applications to power vehicles. Multiple batteries or battery cells are connected to one another in one of series, parallel and a combination to form a battery core pack. The one or more battery core packs are thereafter positioned within the battery packs. The battery pack is provided with a housing having accommodation spaces defined thereon to receive the multiple battery cells. In order to ensure efficient operation of the battery cells, the multiple battery cells are required to be securely retained within the accommodation spaces defined within the battery pack.

Multiple approaches exist for securely retaining the battery cells within an accommodation space of the battery pack. One such approach includes filling the accommodation space with an adhesive subsequent to placing the battery cells within the accommodation space. The battery cells are securely retained within the accommodation space when the adhesive is cured.

During operation, owing to the continuous usage, exposure to heat, and various other electro-chemical reactions within the battery cells, at least one of the multiple cells may be susceptible damage. In such cases, the at least one damaged battery pack is required to be serviced or replaced to ensure efficient operation of the battery pack. To do so, user or personnel has to break up the adhesive to free the at least one damaged battery cell. However, since the adhesive is shared by cells neighboring the at least one damaged cell, the user or personnel may be required to break up the entire adhesive formed within the accommodation space. By doing so, the damaged cell as well as the neighboring cells are dislodged. Subsequent to replacing or servicing the damaged cell, the user or personnel is required to once again apply the adhesive to securely retain the one or more damaged cells and the neighboring cells within the accommodation space. As such, a large amount of adhesive is required during manufacturing as well during servicing, which thereby increases the manufacturing and servicing cost of the battery pack.

Further, as the multiple battery cells are covered by the adhesive, heat dissipation of the multiple battery cells is reduced. Reduced heat dissipation causes the battery pack to operate at a capacity lesser than what the battery pack was designed for, thereby leading to inefficient operation and reduced lifetime of the battery pack.

In view of the above, there is a need for a battery pack capable of retaining each of the multiple battery cells without compensating for the heat dissipation and efficiency of the battery pack.

### SUMMARY OF THE INVENTION

One or more embodiments of the present invention provide a cell retainer assembly and a method for retaining each of a plurality of cells within a battery pack.

In one aspect of the invention, a cell retainer assembly for a battery pack is provided. The cell retainer assembly includes a cell holder unit disposed within a housing of the battery pack. The cell holder unit includes a first member and a second member coupled on to a periphery of the first member. The first member includes a first set of through holes to receive and position a first end of a plurality of cells therein. The second member includes a second set of through holes to receive and position a second end of the plurality of cells therein. The cell retainer assembly further includes at least one groove formed at one of a first end of the first set of through holes and a second end of the second set of through holes. The at least one groove is formed along an internal portion of one of the first and the second set of through holes. Length of the at least one groove is lesser than a length of each of the first and the second set of through holes.

In another aspect of the invention, a method of retaining each of a plurality of cells within a battery pack is provided. The method includes positioning a first end of the each of the plurality of cells within a first set of through holes defined on a first member of a cell holder unit and a second end of the each of the plurality of cells within a second set of through holes defined on a second member of the cell holder unit. The method includes the step of applying adhesive to the at least one groove formed at a first end of the first set of through holes and a second end of the second set of through holes. The at least one groove is defined along an internal portion of the first and the second set of through holes. Thereafter, the method includes retaining the each of the plurality of cells within the first and the second set of through holes.

Other features and aspects of this invention will be apparent from the following description and the accompanying drawings. The features and advantages described in this summary and in the following detailed description are not all-inclusive, and particularly, many additional features and advantages will be apparent to one of ordinary skill in the relevant art, in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

Reference will be made to embodiments of the invention, examples of which may be illustrated in the accompanying figures. These figures are intended to be illustrative, not limiting. The accompanying figures, which are incorporated in and constitute a part of the specification, are illustrative of one or more embodiments of the disclosed subject matter and together with the description explain various embodiments of the disclosed subject matter and are intended to be illustrative. Further, the accompanying figures have not necessarily been drawn to scale, and any values or dimensions in the accompanying figures are for illustration purposes only and may or may not represent actual or preferred values or dimensions. Although the invention is generally described in the context of these embodiments, it should be understood that it is not intended to limit the scope of the invention to these particular embodiments.

FIG. 1 is a block diagram of an environment to which a battery pack is implemented, according to one or more embodiments of the present invention;

FIG. 2A is a housing of the battery pack of FIG. 1, in accordance with one or more embodiments of the present invention;

FIG. 2B is a top cover of the housing of the battery pack of FIG. 1, in accordance with one or more embodiments of the present invention;

FIG. 3A is a top perspective view of a first member of the cell holder unit of the battery pack of FIG. 1, in accordance with one or more embodiments of the present invention;

FIG. 3B is a bottom perspective view of the first member of the cell holder unit of the battery pack of FIG. 1, in accordance with one or more embodiments of the present invention;

FIG. 3C is a perspective view of a second member of the cell holder unit of the battery pack of FIG. 1, in accordance with one or more embodiments of the present invention;

FIG. 3D is a zoomed in view of the second member of the cell holder unit of the battery pack of FIG. 1, in accordance with one or more embodiments of the present invention;

FIG. 3E is an exemplary illustration of a plurality of cells of the battery pack of FIG. 1, in accordance with one or more embodiments of the present invention;

FIG. 4 is an exploded view of the battery pack of FIG. 1, in accordance with one or more embodiments of the present invention;

FIG. 5 is a sectional view of a cell holder unit of the battery pack of FIG. 1, in accordance with one or more embodiments of the present invention; and

FIG. 6 is a flow chart of a method of retaining a plurality of cells within the battery pack of FIG. 1, according to one or more embodiments of the present invention.

### DETAILED DESCRIPTION OF THE INVENTION

Reference will now be made in detail to specific embodiments or features, examples of which are illustrated in the accompanying drawings. Wherever possible, corresponding or similar reference numbers will be used throughout the drawings to refer to the same or corresponding parts. References to various elements described herein, are made collectively or individually when there may be more than one element of the same type. However, such references are merely exemplary in nature. It may be noted that any reference to elements in the singular may also be construed to relate to the plural and vice-versa without limiting the scope of the invention to the exact number or type of such elements unless set forth explicitly in the appended claims. Moreover, relational terms such as first and second, and the like, may be used to distinguish one entity from the other, without necessarily implying any actual relationship or between such entities.

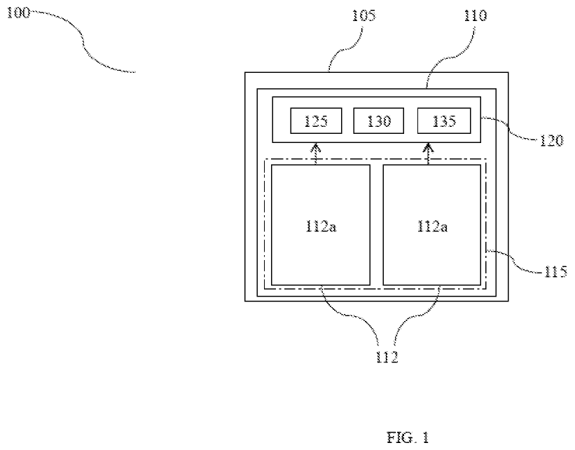

FIG. 1 illustrates a block diagram of an environment 100 to which a battery pack 105 is implemented, according to one or more embodiments of the present invention. In one embodiment, the battery pack 105 is adapted to be utilized as a source of power in electric vehicles, telecommunication devices, household devices and the like. For the purpose of understanding and description, the environment 100 is described with respect to a single battery pack 105. It is, however, to be understood that multiple battery packs may be used as per the requirement of a user or operational requirements, without limiting and deviating from the scope of the present disclosure.

The battery pack 105 requires multiple components placed within a housing 110 of the battery pack 105 to ensure efficient operation of the battery pack 105. In this regard, the housing 110 includes a plurality of cell core packs 112 disposed within the housing 110 of the battery pack 105. For the purpose of description and illustration, the plurality of cell core packs 112 is described with respect to a first cell core pack 112a and a second cell core pack 112b. It is, however, to be understood that the plurality of cell core packs 112 may include ‘n’ number of core packs as per an operational requirement of the battery pack 105. The plurality of cell core packs 112 is specifically positioned within a cell retainer assembly 115 within the housing 110. Constructional features and arrangement of the plurality of cell core packs 112 within the cell retainer assembly 115 of the housing 105 will be explained in detail with respect to the following figures.

The plurality of cell core packs 112 are further communicably coupled to a Battery Management Unit (BMU) 120. In one embodiment, the BMU 120 is positioned within the battery pack 105. In alternate embodiments, the BMU 120 is located at a location remotely accessible by the user.

The BMU 120 is configured to receive and temporarily store data pertaining to multiple operational parameters of plurality of cell core packs 112. The multiple operational parameters are one of, but not limited to, current, voltage, and temperature of the battery pack 105. In one embodiment, the BMU 120 further transmits the data to a server (not shown) via a network. The server may be implemented in a variety of computing systems, such as a mainframe computer, a network server, cloud, and the like. The server is in communication with the BMU 120 of the battery pack 105 via the network. In one embodiment, a Secure Hardware Extension (SHE) unit is embedded within the battery pack 105. The SHE unit ensures that a secure communication of data takes place between the battery pack 105 and the server, thereby preventing third party access to data. In an embodiment, the network can include wired and/or wireless connections such as, but not limited to, local area network (LAN), Bluetooth, Near Field Communication (NFC), infrared, WIFI, GPRS, LTE, Edge and the like.

Subsequent to transmission of the data, copy of the relevant data is automatically removed from the BMU 120. By doing so, ensures that the BMU 120 is not accumulated with previously stored data which is already transmitted to the server 135. Advantageously, the BMU 120 is not burdened with large volume of data beyond the capacity of the BMU 120, thereby ensuring that effective monitoring service is provided and improving the operational efficiency of the BMU 120.

The BMU 120 may include at least one processor 125, an input/output (I/O) interface unit 130, and a memory 135. The at least one processor 125 may be implemented as one or more microprocessors, microcomputers, microcontrollers, digital signal processors, central processing units, state machines, logic circuitries, and/or any devices that manipulate signals based on operational instructions. Among other capabilities, the at least one processor 125 is configured to fetch and execute computer-readable instructions stored in the memory 135.

The I/O interface unit 130 may include a variety of software and hardware interfaces, for example, a web interface, a graphical user interface, Light Emitting Diode (LED) and the like. The I/O interface unit 130 may allow the user to interact with the BMU 120 directly or through a user device. Further, the I/O interface unit 130 may enable the BMU 120 to communicate with other computing devices, such as the server and external data servers (not shown). The I/O interface 130 may facilitate multiple communications within a wide variety of networks and protocol types, including wired networks, for example, LAN, cable, etc., and wireless networks, such as WLAN, cellular, or satellite. In one embodiment, The I/O interface unit 130 may include one or more ports for connecting a number of devices to one another or to another server.

The memory 135 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

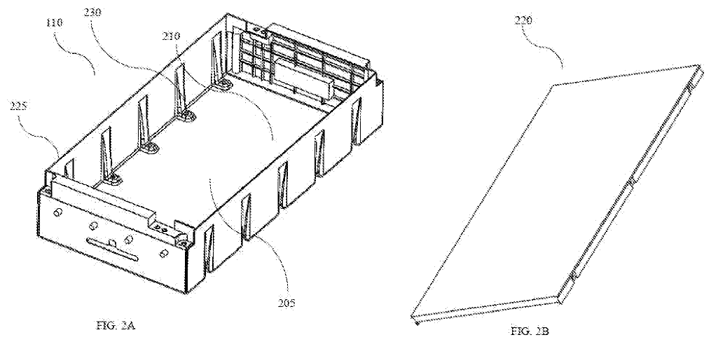

Referring to FIGS. 2A-2B, FIG. 2A illustrates the housing 110 of the battery pack 105, according to one or more embodiments of the present invention. The housing 110 is a hollow enclosure within which the multiple components essential to operation of the battery pack 105 is arranged. The multiple components are arranged in such a way so as to ensure compactness of the battery pack 105 without compromising on safety and efficiency of the battery pack 105. The arrangement of the components within the housing 110 will be explained in detailed with respect to the following figures. The housing 110 includes at least one open end 205 and a rear end 210 opposite and distal to the at least one open end 205.

A shape and size of the housing 110 may vary based on an application in which the battery pack 105 is required to be utilized. In the illustrated embodiment, the battery pack 105 is of rectangular shape. However, in alternate embodiments, the battery pack 105 may be, but not limited to, a square shape without deviating from the scope of the present disclosure. In a preferred embodiment, the housing 110 is made of materials which are thermally conductive to enable heat dissipation from within and thereby prevent damage to the battery pack 105. In an alternate embodiment, the housing 110 is made of thermally insulating materials, such as plastic.

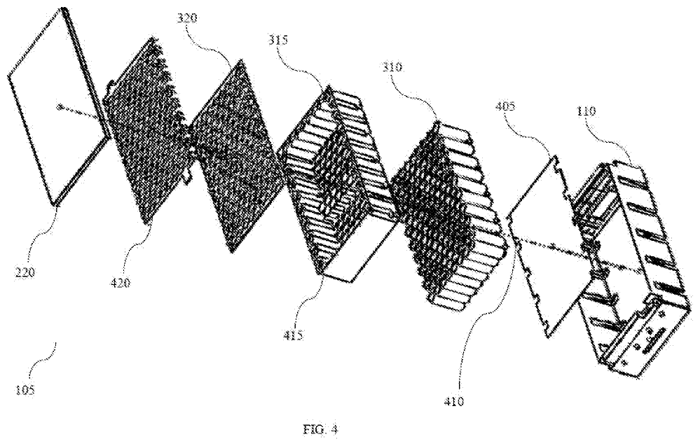

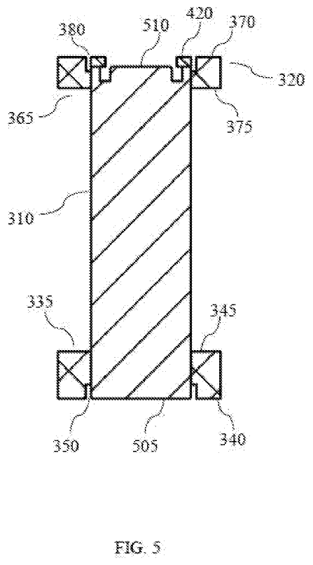

Further, in one embodiment, the housing 110 further includes a cooling plate 405 (as shown in FIG. 4) disposed within the housing 110 of the battery pack 105. More specifically, the cooling plate 215 is disposed via the at least one open end 205 of the housing 110 and positioned on the rear end 210 of the housing 110. The cooling plate 215 is made of thermally conductive materials to aid in maintaining an ambient temperature within the housing 110, and thereby within the battery pack 105. Accordingly, the battery pack 105 is adapted to, advantageously, charge and discharge efficiently. The cooling plate 215 is made of thermally insulating materials, to prevent flame propagation during an event of thermal runaway, and electrically insulating materials. In another embodiment, the cooling plate 215 is a thermally conductive paste applied on the rear end 210 of the housing 110 of the battery pack 105. In yet another embodiment, as the housing 110 is made of thermally insulating materials, the cooling plate 215 may be optional and need not be mandatorily disposed within the housing 110 of the battery pack 105.

The battery pack 105 further includes a top cover 220, as illustrated in FIG. 2B. The top cover 215 is detachably coupled to a periphery 225 of the at least one open end 205 of the housing 110 via fasteners. Shape of the top cover 220 is required to be in proportion with the shape of the housing 110 in order to ensure accurate coupling of the housing 110 and the top cover 220. The top cover 220 is preferably made of materials which are thermally conductive and flame retardant.

In one embodiment, the housing 110 further includes multiple mounting ports 230 are defined on the rear end 210 of the housing 110. The mounting ports 230 are adapted to couple the cell retainer assembly 115 to the rear end 210 of the housing 110 of the battery pack 105 via fasteners. In another embodiment, the cell retainer assembly 115 is coupled to the rear end 210 of the housing 110 via adhesives, such as, but not limited to, Loctite AA3963.

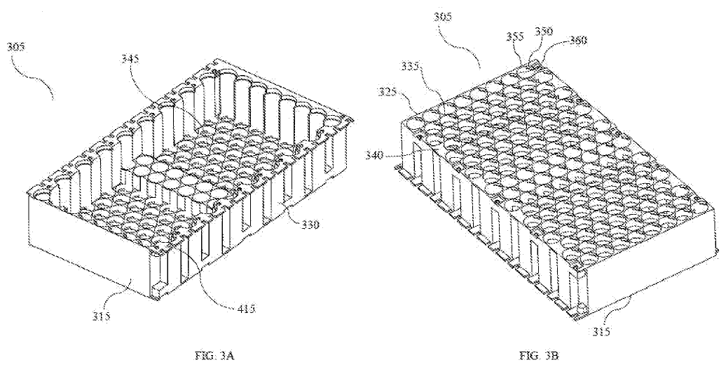

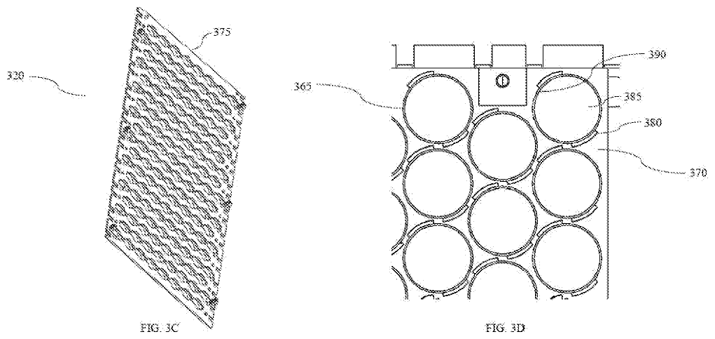

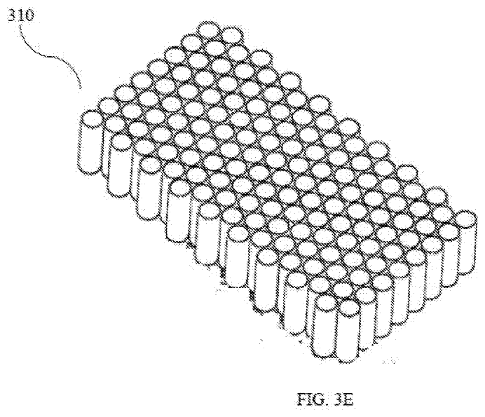

Referring to FIG. 3A-3E, FIG. 3A-3B illustrates a top perspective view and a bottom perspective view of a cell holder unit 305 of the cell retainer assembly 115, according to one or more embodiments of the present invention. The cell holder unit 305 is adapted to hold and securely retain at least one of the plurality of cell core packs 112 therein. Each of the plurality of cell core packs 112 include a plurality of cells 310 (as shown in FIG. 3E) electrically coupled to each other in one of a series connection, a parallel connection and a combination thereof via an at least one connecting element 420 (as shown in FIG. 4). The connecting element is one of, but not limited to, a bus bar, wires, and a combination thereof.

In one embodiment, each of the plurality of cells 310 is one of, but not limited to, a Lithium ion (Li-ion), a Lead acid gel, and Nickel metal hydride. In an alternate embodiment, composition of each of the plurality of cells 310 is lithium or lithium polymer cells (referred to as “lithium”) combined with nickel hydrate battery cells. In alternate embodiments, any suitable battery cell composition may be used, including, but not necessarily limited to, lithium ion, zinc air, zinc oxide, super charged zinc oxide, and fuel cells. Further, a number of the plurality of cells 310 to be disposed within the cell holder unit 305 of the battery pack 105 is dependent on the application and the operational requirements of the application of the battery pack 105. As mentioned earlier, the plurality of cells 310 of each of the plurality of cell core packs 112 are adapted to be received and positioned within the cell holder unit 305 of the cell retainer assembly 115 of the battery pack 105. In this regard, the cell holder unit 305 includes a first member 315 and a second member 320 (as shown in FIG. 3C). In this regards, and more specifically, FIGS. 3A-3B illustrates a top perspective view and a bottom perspective view of the first member 315 of the cell holder unit 305, according to one or more embodiments of the present invention.

As per the illustrated embodiment, the first member 315 includes a base 325 and a plurality of walls 330 defining an open ended enclosure to receive the plurality of cells 310 of the at least one of the plurality of cell core packs 112 therein. In an alternate embodiment, the first member 315 includes simply the base 325 upon which the plurality of cells of the at least one of the plurality of cell core packs 112 are received.

The base 325 of the first member 315 further includes a first set of through holes 335 defined between a first surface 340 and a second surface 345 of the base 325. Each of the first set of through holes 335, hereinafter referred to as the “first through holes 335”, are defined equidistant from each other. Shape and dimensions of the first through holes 335 are adapted to conform with a shape of the plurality of cells 310. In addition, as per the illustrated embodiment, the first surface 340 of the base 325 of the first member 315 is a projection free surface.

The first member 315 of the cell holder unit 305 further includes at least one groove 350 defined on the first surface 340 of the first member 315. More specifically, the at least one groove 350, hereinafter referred to as “the grooves 350” is formed at a first end 355 of the first through holes 335, along an internal portion 360 of the first through holes 335. In addition, a length of each of the grooves 350 is lesser than a length of each of the first through holes 335.

Referring to FIGS. 3C-3D, the cell holder unit 305 further includes the second member 320. The second member 320 includes a second set of through holes 365 formed between a first surface 370 and a second surface 375 of the second member 320. Each of the second set of through holes 365, hereinafter referred to as “the second through holes 365” is defined on the second member 320 such that each of the first through holes 335 and each of the second through holes 365 are aligned in line with each other when placed over one another.

Similar to the first through holes 335, each of the second through holes 365 includes at least one groove 380 defined on the second surface 375 of the second member 320. More specifically, the at least one groove 380, hereinafter referred to as “the grooves 380” is formed at a second end 385 of the second through holes 365 and along an internal portion 390 of the second through holes 365. In addition, a length of each of the grooves 380 is lesser than a length of each of the second through holes 365.

As per the preferred embodiment of the present invention, each of the first member 315 and the second member 320 includes the grooves 350, 380 defined thereon, respectively. However, in alternate embodiments, only one of the first member 315 and the second member 320 include a groove defined thereon.

FIG. 4 illustrates an exploded view of the battery pack 105, according to one or more embodiments of the present invention. The battery pack 105 includes the housing 110 having the open end 205 and the rear end 210 opposite to and distal to the open end 205. The battery pack 105 further includes the cooling plate 405 disposed within the open end 205 of the housing 110. The cooling plate 405 is disposed along a longitudinal axis 410 of the housing 110 and is positioned in contact with the rear end 210 of the housing 110. In one embodiment, the cooling plate 405 is in the form of the plate coupled to the rear end 210 of the housing 110 via one of fasteners and adhesives. In another embodiment, the cooling plate 405 is a cooling paste applied onto the rear end 210 of the housing 110.

Thereafter, the cell holder unit 305 is disposed along the longitudinal axis 410 via the open end 205 of the housing 110. As mentioned earlier, the cell holder unit 305 includes the first member 315 and the second member 320. The second member 320 is adapted to be coupled to a periphery 415 (as shown in FIG. 2) of the first member 315. In one embodiment, the first member 315 and the second member 320 are coupled to each other via one of, but not limited to, welding, ultrasonic welding, and by applying adhesives to form a single integrated unit. Thereafter the plurality of cells 310 are adapted to be slidably inserted and received within each of the first through holes 335 of the first member 315 and the second through holes 365 of the second member 320. Further, owing to the lack of any stoppers at each of the first end 355 of the first through holes 335 and the second end 385 of the second through holes 365, the plurality of cells is adapted to slidably inserted from any one of the first through holes 335 and the second through holes 365. Each of the plurality of cells 310 electrically coupled to each via the connecting element 420. In the illustrated embodiment, the connecting element 420 is bus bars. In alternate embodiments, the connecting element 420 is wires. Further, the connecting element 420 is coupled to one of the first surface 340 of the first member 315 and the first surface 370 of the second member 320.

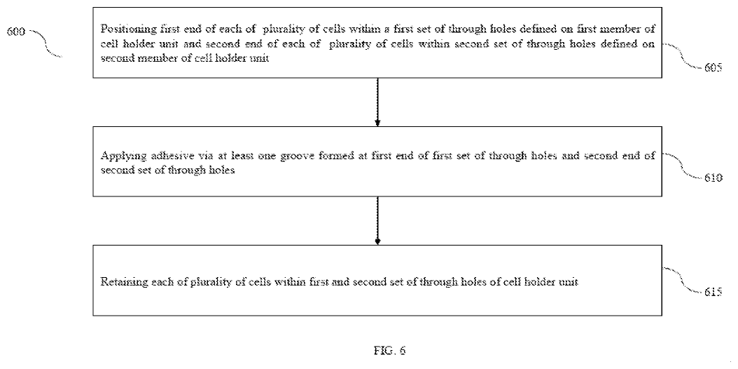

Referring to FIG. 5, each of the plurality of cells 310 is positioned within each of the first through holes 335 and the second through holes 365. The plurality of cells 310 are positioned such that a first end 505 of each of the plurality of cells 310 is in line with the first surface 340 of the first member 315 and a second end 510 of each of the plurality of cells 310 is in line with the second surface 375 of the second member 320. On positioning each of the plurality of cells 310 within the respective first through holes 335 and the second through holes 365, the grooves 350, 380 and each of the plurality of cells form a well there between. Subsequently, adhesive is one of poured and applied within the groves 350, 380. Owing to application of adhesive within the grooves 350, 380, the plurality of cells 310 are securely retained within the first and the second through holes 335, 365.

As each of the first and the second through holes 335, 365 are provided with respective grooves 350, 380, the adhesives are not shared by neighboring cells of the plurality of cells 310. Accordingly, each of the plurality of cells 310 are individually and securely retained within each of the first and the second through holes 335, 365, respectively. Advantageously, during service or maintenance of the battery pack, individual cells from the plurality of cells 310 may be removed without causing any disturbances to neighboring cells.

Referring to FIG. 4, the cell holder unit 305, as such, is disposed via the longitudinal axis 410 within the housing 110. The cell holder unit 305 is disposed such that the first member 315 is in close proximity to the cooling plate 405. In one embodiment, the mounting ports 230 provided on the rear end 210 of the housing 110 aids in fastening the cell holder unit 305 is coupled to the housing 110 via fasteners.

In addition, as mentioned earlier, the first surface 340 of the first member 315 is projection free, i.e., a flat surface. The flatness of the first surface 340 aids in heat dissipation of the plurality of cells 310 without requirement of any additional heat dissipation.

The battery pack 105 further includes the top cover 220. The top cover 220 is detachably coupled to the periphery 225 of the at least one open end 207 of the housing 110 and along the longitudinal axis 410 of the housing 110.

Various embodiments disclosed herein are to be taken in the illustrative and explanatory sense and should in no way be construed as limiting of the present disclosure.

### INDUSTRIAL APPLICABILITY

The present disclosure provides a cell retainer assembly for the battery pack 105 and a method for retaining the plurality of cells 310 within the battery pack 105. The battery pack 105 includes the housing 110, the cell holder unit 305 having the first member 315 and the second member 320 disposed within the housing 110. The first member 315 and the second member 320 of the cell holder unit 305 is integrated into the single unit to reduce the number of components and thereby efficiently utilize space. Each of the first member 315 and the second member 320 is provided with the first and the second through holes 335, 365. Each of the first and the second through holes 335, 365 includes grooves 350, 380 defined thereon to receive adhesive. The application of adhesive within the grooves 350, 380 aid in securely and individually retaining each of the plurality of cells within the respective first and the second through holes 335, 365. In addition, owing to the flat surface of the first surface 340 of the first member 315, heat dissipation is achieved without any additional component.

FIG. 6 is a flow chart of a method 600 of retaining each of the plurality of cells 310 within the battery pack 105, according to one or more embodiments of the present invention. For the purpose of description and explanation, the method 600 is described with respect to the embodiment as illustrated in FIG. 5.

At step 605, the method 600 includes the step of positioning the first end 505 of each of the plurality of cells 310 within the first through hole 335 defined on the first member 315 of the cell holder unit 305. Likewise, the second end 510 of each of the plurality of cells 310 is positioned within the second through hole 365 defined on the second member 320 of the cell holder unit 305.

At step 610, the method 600 includes the step of applying adhesive via the groove 350 formed at the first end 355 of the first through hole 335 and the groove 380 formed at the second end 385 of the second through hole 365. The adhesive so applied is allowed to one of cure naturally and by exposing the adhesive to Ultra Violet (UV) light.

At step 615, the method 615 includes the step of securely retaining each of the plurality of cells 310 within the respective first and the second set of through holes 335, 365. By doing so, each of the plurality of cells 310 are securely and individually retained therein.

While aspects of the present invention have been particularly shown and described with reference to the embodiments above, it will be understood by those skilled in the art that various additional embodiments may be contemplated by the modification of the disclosed machines, systems and methods without departing from the scope of what is disclosed. Such embodiments should be understood to fall within the scope of the present invention as determined based upon the claims and any equivalents thereof.

1. A cell retainer assembly (115) for a battery pack (105), the cell retainer assembly comprising:
a cell holder unit (315) disposed within a housing (110) of the battery pack (105), the cell holder unit (315) comprising:
a first member (315) having a first set of through holes (335) adapted to receive and position a first end (505) of a plurality of cells (310) therein; and
a second member (320) coupled to a periphery (415) of the first member (315), the second member (320) having a second set of through holes (365) adapted to receive and position a second end (510) of the plurality of cells (310) therein; and
at least one groove (350,380) formed at one of a first end (355) of the first set of through holes (335) and a second end (385) of the second set of through holes (365),
the at least one groove (350,380) formed along an internal portion (360, 390) of one of the first set of through holes (335) and the second set of through holes (365),
the at least one groove (350,380) having a length lesser than a length of each of the first and the second through holes (335,365),
the at least one groove (350,380) adapted to receive adhesive therein to retain each of the plurality of cells (310) within the first and the second set of through holes (335, 365).

2. The cell retainer assembly (115) as claimed in claim 1, wherein each of the first set of through holes (335) is defined between a first surface (340) and a second surface (345) of the first member (315), and each of the first set of through holes (335) is equidistant from each other.

3. The cell retainer assembly (115) as claimed in claim 1, wherein each of the second set of through holes (365) is defined between a first surface (370) and the second surface (375) of the second member (320), and each of the second set of through holes (365) is aligned in line with each of the first set of through holes (335).

4. The cell retainer assembly (115) as claimed in claim 1, wherein each of the plurality of cells (310) are interconnected to each other via at least one connecting element (420), the at least one connecting element (420) coupled to one of a first surface (340) of the first member (315) and a second surface (375) of the second member (320).

5. The cell retainer assembly (115) as claimed in claim 1 comprises a cooling plate (405) positioned adjacent to the second surface (345) of the first member (315) of the cell holder unit (305) to aid in one of thermal conduction, electrical isolation, and a combination thereof of the plurality of cells (310).

6. The cell retainer assembly (115) as claimed in claim 1, wherein the second surface (345) of the first member (315) of the cell holder unit (305) is coupled to the housing (110) via fasteners.

7. The cell retainer assembly (115) as claimed in claim 1, wherein the first and the second member (315, 320) are coupled to each other via one of, but not limited to, welding, ultrasonic welding, and applying adhesives to form an integrated unit.

8. A method (600) of retaining each of a plurality of cells (310) within a battery pack (105), the method (600) comprising:
positioning a first end (505) of each of the plurality of cells (310) within a first set of through holes (335) defined on a first member (315) of a cell holder unit (305) and a second end (510) of each of the plurality of cells (310) within a second set of through holes (365) defined on a second member (320) of the cell holder unit (305);
applying adhesive via at least one groove (350, 380), the at least one groove (350, 380) defined at a first end (355) of the first set of through holes (335) and a second end (385) of the second set of through holes (356), and the at least one groove (350,380) defined along an internal portion (360, 390) of the first set of through holes (335) and the second set of through holes (365);
curing of the adhesive applied within the at least one groove (350,380); and
retaining each of the plurality of cells (310) within the first and the second set of through holes (335, 365) of the cell holder unit (305) of a cell retainer assembly (115).
